(19) United States
(12) Patent Application Publication
(10) Pub. No.: US 2026/0056172 A1
(43) Pub. Date: Feb. 26, 2026

(54) DATA PROCESSING DEVICE FOR LIQUID CHROMATOGRAPH

(71) Applicant: SHIMADZU CORPORATION, Kyoto (JP)

(72) Inventors: Tomohiro KAWASE, Kyoto-shi (JP); Harunori KAWAI, Kyoto-shi (JP)

(73) Assignee: SHIMADZU CORPORATION, Kyoto (JP)

(21) Appl. No.: 19/277,521

(22) Filed: Jul. 23, 2025

(30) Foreign Application Priority Data
Aug. 20, 2024 (JP) 2024-139199

(51) Int. Cl. G01N 30/86; B01D 15/08; G01N 30/72

(52) U.S. Cl. CPC G01N 30/8675; B01D 15/08; G01N 30/7233; G01N 30/8631

(57) ABSTRACT

A data storage section holds first chromatogram data acquired by a main detector along with first mass spectrometry data under a first analysis condition and second chromatogram data acquired by the main detector along with second mass spectrometry data under a second analysis condition. A chromatogram peak extractor extracts a first peak and a second peak from the first and second chromatogram data, respectively. A mass-to-charge ration acquirer acquires mass-to-charge ratios of ions at the first peak as well as those of ions at the second peak. A molecular weight calculator calculates a molecular weight from the mass-to-charge ratios of the first peak and a molecular weight from the mass-to-charge ratios of the second peak. A peak correspondence determiner determines the correspondence between the first and second peaks from the molecular weight of the first peak and that of the second peak.

### TECHNICAL FIELD

The present invention relates to a data processing device for a liquid chromatograph.

### BACKGROUND ART

Liquid chromatographs have been widely used in the analysis of liquid samples. In many liquid chromatographs, an absorbance detector configured to irradiate a compound with light having a predetermined wavelength and to detect the absorbance of the compound is provided as a detector for detecting compounds separated by a column.

In the production, development and other activities related to medicinal products, when a liquid sample containing an intended compound (“target compound”) is to be analyzed, an assessment should be performed for determining an analysis condition (analysis method) under which the target compound can be satisfactorily separated from other compounds (e.g., impurities) by the column. For the assessment of the analysis condition, a plurality of analysis conditions with varying compositions and mixture ratios of solvents constituting the mobile phase are set, and the target compounds and other components in the liquid sample are detected using each of those analysis conditions. Since the retention time of each compound changes depending on the analysis condition, it is necessary to perform the task of locating the peak corresponding to each compound in the chromatogram (“peak tracking”) for each of the analysis conditions. According to a conventional procedure, the liquid sample is measured with a liquid chromatograph further equipped with a mass spectrometer as another detector, and the peak tracking is performed based on the mass-to-charge ratio of a base peak in a mass spectrum (the peak with the highest intensity in the mass spectrum) acquired at the position of each peak in a chromatogram (for example, see Non Patent Literature 1).

### CITATION LIST

### Non Patent Literature

Non Patent Literature 1: Shinichi Fujisaki, “MS Piiku Torakkingu Wo Mochiita Bunsekihou Kaihatsu No Kouritsuka (Improvement of Efficiency of Analysis-Method Development Using MS Peak Tracking)”, [online], January 2024, Shimadzu Corporation, [accessed on Aug. 20, 2024], the Internet

### SUMMARY OF INVENTION

### Technical Problem

When a mass spectrometric analysis of a compound having a medium to high molecular weight such as a protein, peptide or nucleic acid is performed, a plurality of kinds of multiply charged ions having different numbers of charges are detected for the same compound. The intensity of each of the mass peaks of the multiply charged ions changes depending on the analysis condition. Therefore, the spectral pattern of the mass spectrum changes for each analysis condition even when the compound is the same, which may cause an indefiniteness in the mass-to-charge ratio of the base peak, thus making it difficult to perform the peak tracking.

The problem to be solved by the present invention is to provide a technique which allows stable peak tracking without being affected by an indefiniteness in the spectral pattern of the mass spectrum.

### Solution to Problem

The present invention developed for solving the previously described problem is a data processing device for a liquid chromatograph including a column configured to separate compounds contained in a liquid sample as well as a main detector and a mass spectrometer both configured to detect compounds separated by the column, the main detector being a different type of detector from a mass spectrometer, the data processing device including:
a storage section holding first chromatogram data acquired by the main detector and first mass spectrometry data acquired by the mass spectrometer by a measurement of a liquid sample containing a target compound under a first analysis condition, as well as second chromatogram data acquired by the main detector and second mass spectrometry data acquired by the mass spectrometer by a measurement of the liquid sample under a second analysis condition;
a chromatogram peak extractor configured to extract a first peak from the first chromatogram data and to extract a second peak from the second chromatogram data;
a mass-to-charge ratio acquirer configured to acquire, from the first mass spectrometry data, the mass-to-charge ratios of a plurality of ions detected at the position of the first peak and to acquire, from the second mass spectrometry data, the mass-to-charge ratios of a plurality of ions detected at the position of the second peak;
a molecular weight calculator configured to calculate, from the mass-to-charge ratios of the plurality of ions detected at the position of the first peak, the molecular weight of a compound corresponding to the plurality of ions, and to calculate, from the mass-to-charge ratios of the plurality of ions detected at the position of the second peak, the molecular weight of a compound corresponding to the plurality of ions; and
a peak correspondence determiner configured to determine the correspondence between the first peak and the second peak based on the molecular weight calculated for the first peak and the molecular weight calculated for the second peak.

### Advantageous Effects of Invention

In the data processing device for a liquid chromatograph according to the present invention, the molecular weight of a compound corresponding to a plurality of ions detected by the mass spectrometer at the position of the first peak extracted from the first chromatogram data is calculated based on the mass-to-charge ratios of those ions. Furthermore, the molecular weight of a compound corresponding to a plurality of ions detected by the mass spectrometer at the position of the second peak extracted from the second chromatogram data is calculated based on the mass-to-charge ratios of those ions. The correspondence of the first peak and the second peak is subsequently determined based on the molecular weight calculated for the first peak and the molecular weight calculated for the second peak. According to the present invention, since peak tracking is performed based on the molecular weight rather than the spectral pattern of the mass spectrum, the peak tracking can be performed without being affected by an indefiniteness in the spectral pattern of the mass spectrum.

### BRIEF DESCRIPTION OF DRAWINGS

FIG. 1 is a configuration diagram of the main components of a liquid chromatograph system including a data processing device for a liquid chromatograph according to the present invention.

FIG. 2 is a flowchart concerning the procedure for assessing analysis conditions using the liquid chromatograph system according to the present embodiment.

FIG. 3 is one example of the screen display of an analysis result in the liquid chromatograph system according to the present embodiment.

FIG. 4 is a chromatogram acquired by a measurement of a sample containing a nucleic acid compound under a first analysis condition.

FIG. 5 is a mass spectrum based on measurement data acquired at a peak position in a chromatogram acquired by a measurement of a sample containing a nucleic acid compound under a first analysis condition.

FIG. 6 is a chromatogram acquired by a measurement of a sample containing a nucleic acid compound under a second analysis condition.

FIG. 7 is a mass spectrum based on measurement data acquired at a peak position in a chromatogram acquired by a measurement of a sample containing a nucleic acid compound under a second analysis condition.

### DESCRIPTION OF EMBODIMENTS

One embodiment of the data processing device for a liquid chromatograph according to the present invention is hereinafter described with reference to the drawings. Although the following description is concerned with an analysis of a nucleic acid as a specific example, the compounds to be analyzed are not limited to nucleic acids.

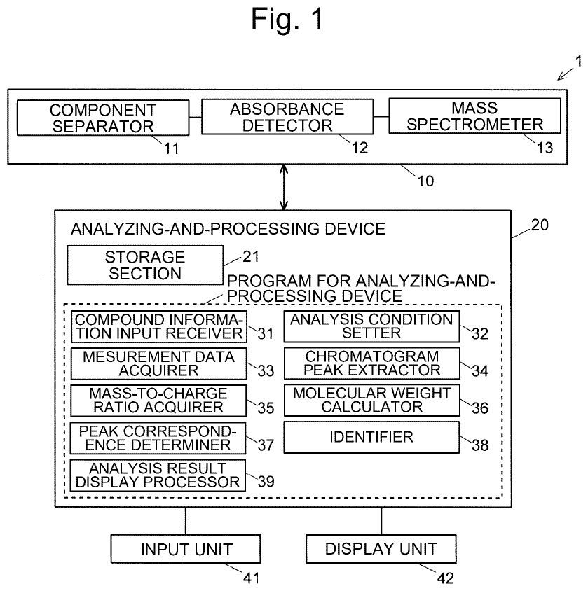

FIG. 1 is a configuration diagram of the main components of a liquid chromatograph system 1 including the data processing device for a liquid chromatograph according to the present embodiment (which may hereinafter be simply called the “data processing device”).

The liquid chromatograph system 1 according to the present embodiment includes a liquid chromatograph 10 as well as an analyzing-and-processing device 20. The analyzing-and-processing device 20 corresponds to the data processing device for a liquid chromatograph in the present invention.

The liquid chromatograph 10 is an analyzer consisting of the combination of a component separator 11, absorbance detector 12 (which corresponds to the main detector in the present invention) and mass spectrometer 13. In the component separator 11, a liquid sample is introduced into a column. The various compounds contained in the liquid sample are separated from each other by the column and exit the same column. In the absorbance detector 12, each component coming from the column is irradiated with light having a predetermined wavelength to detect the absorbance. The absorbance detector 12 in the present embodiment is a photodiode array (PDA) detector.

In the mass spectrometer 13, the components which have passed through the absorbance detector 12 are sequentially ionized, and the resultant ions are separated from each other according to their mass-to-charge ratios in a mass separator before being detected. The mass spectrometer 13 in the present embodiment includes an atmospheric pressure ion source such as an electrospray ion source (ESI) or atmospheric pressure chemical ion source (APCI) and a quadrupole mass separator. In the mass spectrometer 13, a mass spectrometric analysis (MS scan measurement or SIM measurement) of the ions produced from a compound contained in the sample can be performed. The aforementioned ion source and mass separator are mere examples; other types of devices may also be used. For example, a time-of-flight mass separator (ToF), triple quadrupole mass separator or quadrupole time-of-flight mass separator (Q-ToF) may be used as the mass separator. The use of a device having a ToF enables the acquisition of information concerning accurate masses (e.g., with values down to five decimal places) of various ions with a high level of accuracy (e.g., at a mass accuracy of several ppm or even higher). The use of a device having a triple quadrupole mass separator or Q-ToF enables an MS/MS scan measurement, MRM measurement or the like.

The analyzing-and-processing device 20 has a storage section 21. The analyzing-and-processing device 20 also includes, as its functional blocks, a compound information input receiver 31, analysis condition setter 32, measurement data acquirer 33, chromatogram peak extractor 34, mass-to-charge ratio acquirer 35, molecular weight calculator 36, peak correspondence determiner 37, identifier 38, and analysis result display processor 39. For example, the analyzing-and-processing device 20 may actually be a common type of personal computer, with the aforementioned functional blocks embodied by executing, on a processor, a dedicated program for an analyzing-and-processing device pre-installed on the same computer. An input unit 41 consisting of a mouse, keyboard and other devices, as well as a display unit 42 such as a liquid crystal display are connected to the analyzing-and-processing device 20.

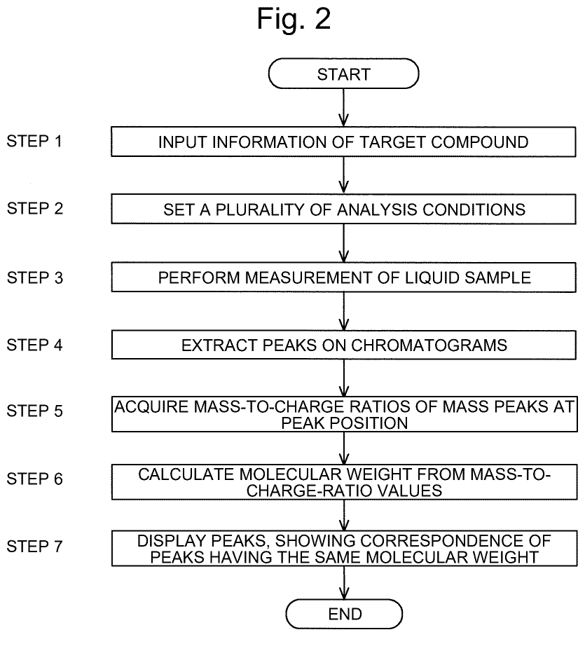

Next, an example of the assessment of analysis conditions (analysis methods) using the liquid chromatograph system 1 according to the present embodiment is described with reference to the flowchart of FIG. 2. Such an assessment of analysis conditions is performed in order to determine the optimum analysis condition for separating the target compound from other compounds in the target sample by the column of the liquid chromatograph.

For example, oligonucleotide therapeutics are produced by chemical synthesis. In the synthetic process, many impurities are produced due to insufficient elongation of nucleotides, poor removal of protecting groups and other related factors. Consequently, the product contains an enormous number of oligonucleotides including impurities. In order to guarantee the safeness of oligonucleotide therapeutics, the concentrations of those impurities need to be lower than their respective specified values. To confirm whether or not this condition is met requires properly isolating each compound. In liquid chromatography, reverse-phase ion-pair chromatography (RP-IP) is known as a generally used separation mode for separating electrically charged substances. In RP-IP, the separation pattern of the compounds changes depending on the concentration of an ion-pair reagent added to the mobile phase and the composition of the organic solvent, and the way this change in separation pattern occurs depends on the chain length and base composition of the oligonucleotide, presence or absence of modified bonds as well as other factors. Therefore, it is necessary to assess analysis conditions for each target sequence and find the optimum separation condition.

A user performs a predetermined input operation to issue a command to initiate an analysis. Then, the compound information input receiver 31 shows, on the display unit 42, a screen for allowing the user to input the molecular weight of the target compound (Step 1).

After the user has entered the molecular weight of the target compound, the analysis condition setter 32 shows, on the display unit 42, a screen for setting the analysis condition for the liquid chromatograph to separate and detect the target compound contained in the sample. For example, this analysis condition includes the kind of mobile phase (various kinds of organic and aqueous solvents) to be used in the liquid chromatograph, the mixture ratio and flow rate of the mobile phase, as well as the temperature of the column oven. It also includes the wavelength of the light used for irradiating the sample liquid in the absorbance detector 12 as well as the analysis condition in the mass spectrometer (e.g., the selection of the range of mass-to-charge ratios in the MS scan measurement). In the development of the analysis condition, it is often the case that a plurality of separation conditions are set which are different in terms of the kind of mobile phase and its mixture ratio while the same analysis condition is set in terms of the wavelength of the light used for irradiating the sample liquid in the absorbance detector 12 and the analysis method in the mass spectrometer. For the present embodiment, ten analysis conditions having different mixture ratios of the mobile phase are set. Needless to say, this number is a mere example and may be arbitrarily changed.

After the user has set a plurality of analysis conditions (Step 2), the measurement data acquirer 33 conducts the measurement of the liquid sample using each of those analysis conditions (Step 3). In this measurement, the compounds contained in the liquid sample are separated from each other in the component separator 11 of the liquid chromatograph 10, and the separated compounds are subjected to a measurement using the absorbance detector 12 as well as a measurement using the mass spectrometer 13. The two sets of measurement data acquired by the absorbance detector 12 and the mass spectrometer 13 are saved in the storage section 21. The measurement data acquired by the absorbance detector 12 shows the change in the intensity of light transmitted through the sample liquid with respect to time. Converting the intensity of light in this measurement data into absorbance yields data of a chromatogram which shows the change in absorbance with respect to time. Meanwhile, in the mass spectrometer 13, for example, an MS analysis over a predetermined range of mass-to-charge ratios is repeatedly performed during the measurement to acquire the measurement data. The obtained data is three-dimensional data which shows the change in the measured intensity of ions with respect to the two axes of time and mass-to-charge ratio. From this measurement data, various types of data can be obtained, including: the total ion current chromatogram (TICC) showing the temporal change of the total intensity of all ions; the extracted ion chromatogram (EIC, which is also called the “mass chromatogram”) showing the temporal change in the intensity of an ion having a specific mass-to-charge ratio; and data of a mass spectrum (MS spectrum) at a specific point in time (or within a specific range of time).

After the measurement data has been obtained, the chromatogram peak extractor 34 reads the measurement data of the absorbance detector 12 from the storage section 21, creates a chromatogram from that data, and extracts a peak on that chromatogram (Step 4).

When a peak has been extracted from the chromatogram of the absorbance detector 12, the mass-to-charge ratio acquirer 35 reads, from the storage section 21, the measurement data acquired by the mass spectrometer 13 during the same measurement. The mass-to-charge ratio acquirer 35 subsequently creates a mass spectrum (acquired by an MS scan measurement) from the measurement data acquired by the mass spectrometer 13 at the position (retention time) of the peak extracted from the chromatogram of the absorbance detector 12 and obtains the values of the mass-to-charge ratios of a plurality of mass peaks located on that mass spectrum (Step 5). As in the present embodiment, when a nucleic acid as a target compound is ionized by an atmospheric pressure ion source, it is often the case that a plurality of kinds of multiply charged ions having different numbers of charges are generated, and a value of the mass-to-charge ratio is obtained for each of those multiply charged ions.

After the mass-to-charge ratios of the plurality of mass peaks on the mass spectrum at the peak position of the chromatogram have been obtained, the molecular weight calculator 36 computes the molecular weight of the compound which produced those multiply charged ions based on the values of the obtained mass-to-charge ratios. This processing is called the “multiply charged ion analysis” or “multiply charged ion deconvolution”. For example, a multiply charged negative ion resulting from the removal of a plurality of protons is expressed by [M+nH]ⁿ⁻. A multiply charged positive ion resulting from the addition of a plurality of protons is expressed by [M+nH]ⁿ⁺. The molecular weight calculator 36 computes the molecular weight M of the compound which produced those multiply charged ions, by assigning the value of the mass-to-charge ratio of each multiply charged ion obtained by the mass-to-charge ratio acquirer 35 to either [M+nH]ⁿ⁻ or [M+nH]ⁿ⁺ according to an analysis condition which determines the polarity of the ions to be generated in the ion source (Step 6). It should be noted that the molecular weight calculator 36 only needs to use a plurality of mass-to-charge ratios that can be assigned to either [M+nH]ⁿ⁻ or [M+nH]ⁿ⁺ as the basis for calculating the molecular weight; it is unnecessary to use all mass-to-charge ratios acquired by the mass-to-charge ratio acquirer 35. A mass spectrum possibly includes noise peaks originating from noise components. Assigning the mass-to-charge ratio of such a noise peak to [M+nH]ⁿ⁻ or [M+nH]ⁿ⁺ yields a useless result that is inconsistent with the molecular weight calculated based on other mass peaks. Accordingly, the molecular weight calculator 36 excludes the values of the mass-to-charge ratios of such useless mass peaks (e.g., noise peaks) when calculating the molecular weight of the compound.

After the previously described processing has been completed for the measurement data acquired under all analysis conditions, the peak correspondence determiner 37 performs the process of determining the correspondence of the peaks on the chromatograms, assuming that the peaks for which the same value of the molecular weight has been obtained are peaks of the same compound. It should be noted that the peak correspondence determiner 37 treats two or more values of the molecular weight as equal values if their difference is within a previously set permissible range. For example, two or more values of the molecular weight whose difference is not larger than 0.5% may be treated as equal values. In this case, for example, if the target compound has a molecular weight of 716, any peak whose molecular-weight difference is not larger than 4 Da is treated as identical. The permissible range may be defined by a ratio to the molecular weight of the target compound or directly defined by an absolute value.

After the previously described processing by the peak correspondence determiner 37 has been completed, the identifier 38 compares the molecular weight of the target compound received through the compound information input receiver 31 with the molecular weight of each set of peaks whose correspondence has been determined by the peak correspondence determiner 37 and identifies the peak set which corresponds the target compound based on the fact that the difference between the two molecular weights is within a previously determined range (e.g., within a range of ±1 Da, inclusive).

After the processing by the identifier 38 has been completed, the analysis result display processor 39 shows chromatograms based on the measurement data of the absorbance detector 12 respectively acquired under the plurality of analysis conditions. Each of the peaks on the chromatograms is annotated by the value of the molecular weight calculated by the molecular weight calculator 36 and the information of the corresponding target compound. The correspondence of the peaks having the same value of the molecular weight calculated by the molecular weight calculator 36 is also visually represented between the different chromatograms (Step 7).

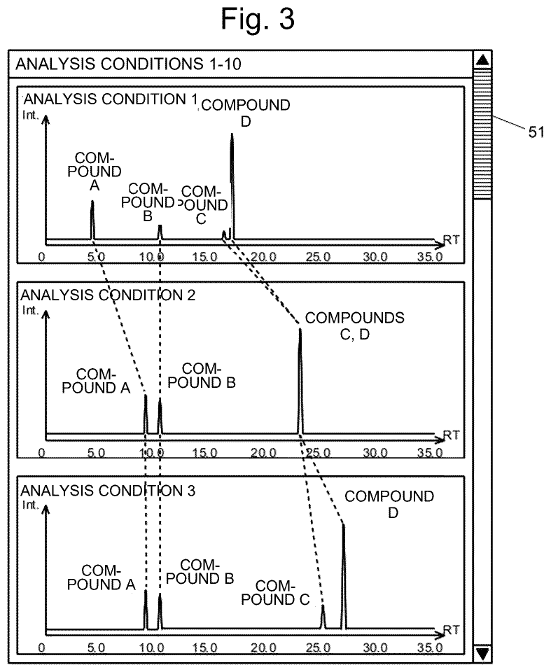

FIG. 3 shows an example of the display screen created by the analysis result display processor 39. In this example, a plurality of chromatograms based on the measurement data of the absorbance detector 12 are shown in a vertically arranged form, in which the value of the molecular weight calculated by the molecular weight calculator 36 for each peak in the chromatograms is shown in the vicinity of the peak top. The lines which connect the peaks having the same value of the molecular weight help to visually recognize the correspondence relationship of the peaks which are considered to have originated from the same compound. There are various possible forms for this display. For example, it is possible to use the same display color for the peaks having the same value of the molecular weight instead of using the line connecting the peaks as in the present example. The screen shown in FIG. 3 also allows the user to perform an operation for selecting a peak. Upon this operation, the analysis result display processor 39 displays a mass spectrum based on the measurement data of the mass spectrometer 13 acquired at the position (retention time) of the selected peak (this mass spectrum is not shown in FIG. 3). Although only chromatograms acquired under three analysis conditions are shown on the screen in FIG. 3, the chromatograms acquired under other analysis conditions can also be shown by an operation using the scroll bar 51 on the screen.

On this screen display, the user visually examines the chromatograms acquired under their respective analysis conditions and determines, as the analysis condition for the target compound, an analysis condition under which the target compound can be sufficiently separated from other compounds (e.g., impurities). The analysis condition thus determined is related to the information of the target compound and stored in the storage section 21. In the case of the development of oligonucleotide therapeutics or similar activities, the chromatogram in which the target compound is sufficiently separated from other compounds allows the user to confirm that none of the impurities contained in the liquid sample exceeds a reference value of the concentration (i.e., the obtained oligonucleotide therapeutic is safe) based on the fact that all peaks of the compounds except for the target compound have peak areas or peak-top heights less than a predetermined reference value.

As shown in FIG. 3, a change in the analysis condition in the liquid chromatograph 10 causes a change in the retention time even when the compound is the same. Furthermore, a simultaneous elution of a plurality of compounds (co-elution) may possibly occur depending on the analysis condition. Therefore, it is necessary to perform “peak tracking” which is the task of determining which peaks on the chromatograms respectively acquired under a plurality of analysis conditions have originated from the same compound.

In a conventional peak-tracking process, the correspondence of the peaks on a plurality of chromatograms is determined by locating, on each chromatogram, the “base peak” which is the peak having the highest intensity in the mass spectrum acquired at the position of each peak on the chromatogram concerned.

In the case of a low-molecular compound, most of the ions generated in the ion source of the mass spectrometer 13 are singly charged ions, and the peaks of those singly charged ions serve as base peaks. Therefore, it is possible to determine the correspondence of the peaks on a plurality of chromatograms by determining the correspondence of the base peaks having the same mass-to-charge ratio.

By contrast, in the case of an analysis of a compound having a medium to high molecular weight (e.g., equal to or higher than 2,000) such as nucleic acids described in the previous embodiment as well as proteins, peptides or similar compounds, or in the case of using an ion source which easily produces multiply charged ions even from low-molecular compounds, the amounts of multiply charged ions change depending on the analysis condition. In some cases, the numbers of charges of the resulting ions (and hence the mass-to-charge ratios of the resulting ions) may also change. Consequently, the base peaks corresponding to the same compound have different values of the mass-to-charge ratio, so that it is difficult to determine the correspondence of the peaks on a plurality of chromatograms originating from the same compound by the conventional technique. Another problem with the use of the base peaks exists in that a high noise component may possibly be present in the mass data and form a noise peak which serves as a base peak. In general, noise peaks occur in an unexpected fashion and their mass-to-charge ratios are unfixed. Therefore, it is impossible to correctly determine the correspondence of the peaks in the chromatograms by the conventional technique if a noise peak is selected as a base peak.

By contrast, in the present embodiment, the molecular weight of the compound from which a plurality of kinds of multiply charged ions were produced is estimated from the mass-to-charge ratios of those ions, and the peaks having the same molecular weight in the chromatograms are identified as corresponding peaks. In summary, the present embodiment uses the information of the molecular weight of the compound rather than the spectral pattern of the mass spectrum (i.e., the information of the intensities of the mass peaks). By such a processing, the correspondence of the chromatogram peaks originating from the same compound can be correctly determined even in the case where the mass-to-charge ratios of the base peaks may change or different kinds of multiply charged ions may be generated depending on the analysis condition. Even when a significant noise component is present in the measurement data, the molecular weight can be calculated without being affected by that noise component.

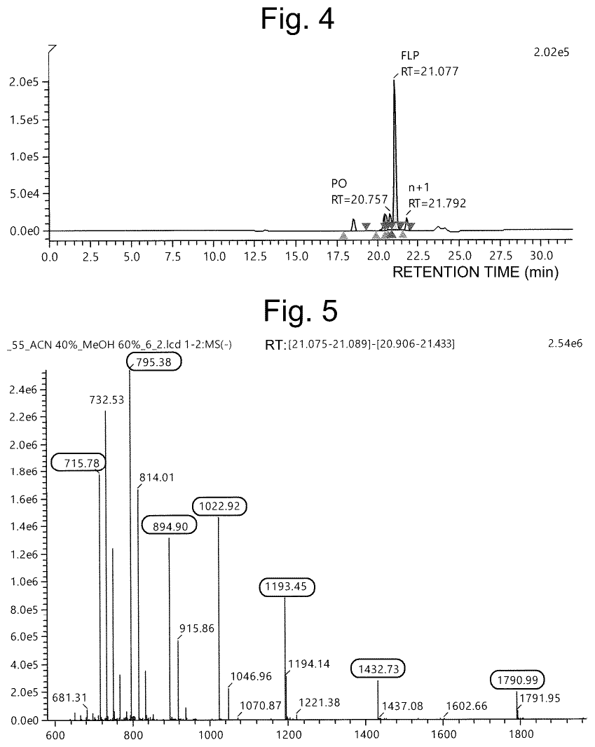

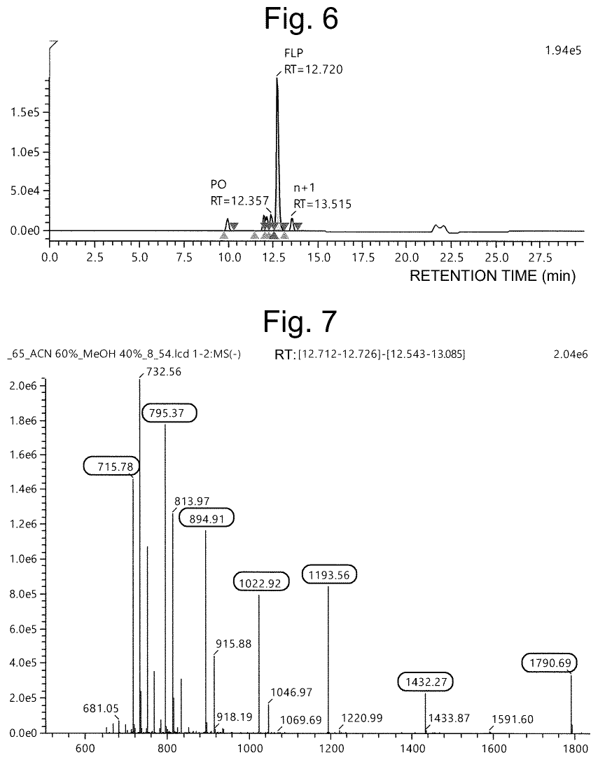

FIGS. 4-7 show examples of the measurement of actual samples. FIG. 4 is a chromatogram based on the measurement data of the PDA detector in a measurement in which a mobile phase consisting of acetonitrile (ACN) and methanol (MeOH) mixed at a ratio of 40% to 60% was used as an organic solvent. FIG. 5 is a mass spectrum based on the measurement data of the mass spectrometer 13 at the position of the peak of FLP (full length product of a 20mer nucleic acid) in FIG. 4. FIG. 6 is a chromatogram based on the measurement data of the PDA detector in a measurement in which a mobile phase consisting of acetonitrile (ACN) and methanol (MeOH) mixed at a ratio of 60% to 40% was used as an organic solvent. FIG. 7 is a mass spectrum based on the measurement data of the mass spectrometer 13 at the position of the peak of FLP (full length product of a 20mer nucleic acid) in FIG. 6.

The position (retention time) of the FLP peak in the chromatogram of FIG. 4 is 21.077 minutes, whereas that of the FLP peak in the chromatogram of FIG. 6 is 12.720 minutes. These results demonstrate that the point in time at which the same compound exits the column changes depending on the analysis condition.

Furthermore, the base peak in the mass spectrum of FIG. 5 is the mass peak at m/z=795.38, whereas the base peak in the mass spectrum of FIG. 7 is the mass peak at m/z=732.56. These results demonstrate that the mass-to-charge ratio of the base peak for the same compound changes depending on the analysis condition.

In the previously described case, if the conventional processing technique based on the base peaks were used, it would be difficult to determine that the peak at the retention time of 21.077 minutes in the chromatogram of FIG. 4 and the peak at the retention time of 12.720 minutes in the chromatogram of FIG. 6 originate from the same compound since the base peak of the mass spectrum corresponding to the former peak is located at a mass-to-charge ratio of 795.38 (FIG. 5) while that of the mass spectrum corresponding to the latter peak is located at a different mass-to-charge ratio, 732.56 (FIG. 7).

By contrast, in the present embodiment, it is possible to correctly determine that both mass spectra in FIGS. 5 and 7 originate from the same compound since the value of the molecular weight calculated based on the mass-to-charge ratios of the mass peaks of a plurality of multiply charged ions having different numbers of charges in the mass spectrum in FIG. 5 is equal to that of the molecular weight calculated based on the mass-to-charge ratios of the mass peaks of a plurality of multiply charged ions having different numbers of charges in the mass spectrum in FIG. 7 (both of which are 7167). It should be noted that the peaks labelled with encircled mass-to-charge ratios in the examples shown in FIGS. 5 and 7 were the peaks which originated from multiply charged ions. In addition, it is most likely that the mass peak at a mass-to-charge ratio of 732.53 in FIG. 5 and the mass peak at a mass-to-charge ratio of 732.56 in FIG. 7 are peaks originating from isotopes (or the like).

The previously described embodiment is a mere example and can be appropriately changed or modified without departing from the spirit of the present invention.

In the previously described embodiment, the measurement data was acquired by performing a measurement of a sample containing a target compound by means of the liquid chromatograph 10. It is also possible to read measurement data acquired beforehand and saved in the storage section, and to process this data in the previously described manner.

The previous descriptions of the embodiment and measurement examples were concerned with an analysis of a nucleic acid. A similar configuration can also be adopted for an analysis of other types of target compounds. Although mass spectra of negative ions were acquired and analyzed in the previously described measurement examples, mass spectra of positive ions may also be acquired and analyzed. Furthermore, the method for calculating the molecular weight may also be different from the previously described embodiment in which the molecular weight was calculated from the mass-to-charge ratios of the mass peaks of a plurality of kinds of multiply charged ions appearing in an MS spectrum and having different numbers of charges. For example, the masses of atoms and molecules that are expected to attach may be registered for a plurality of kinds of adduct ions (i.e., ions to which additional atoms or molecules are attached), and the molecular weight may be calculated from the mass-to-charge ratios of the mass peaks of a plurality of different kinds of adduct ions. Although the molecular weight was calculated from the mass-to-charge ratios of the mass peaks on an MS spectrum in the previously described embodiment, it is also possible to calculate the molecular weight from the mass-to-charge ratios of the mass peaks on an MS/MS spectrum (product ion spectrum). It is also possible to use both the mass-to-charge ratios of the mass peaks on an MS spectrum and those of the mass peaks on an MS/MS spectrum.

In the previously described embodiment, the analysis of the measurement data was performed after the molecular weight of the target compound had been entered by the user, i.e., under the condition that the information of the molecular weight of the target compound was previously known, and the process of identifying the target compound corresponding to the peak set whose correspondence had been determined by the peak correspondence determiner 37 was subsequently performed by the identifier 38. Actually, the determination of the correspondence of the peaks according to the present invention merely requires that the value of the molecular weight corresponding to each peak in a chromatogram is obtained. Accordingly, it is not essential to input the molecular weight of the target compound; the previously described configuration can also be adopted in the case of analyzing an unknown compound (i.e., the molecular weight of the target compound is unknown). In this case, the aforementioned processing by the identifier 38 will be omitted.

Although the liquid chromatograph 10 having the absorbance detector 12 as the main detector was used in the previously described embodiment, the type of main detector may be appropriately selected. However, it should be noted that the testing standards for medicinal products (or the likes) often specify requirements for measurements using absorbance detectors. Furthermore, PDA detectors and other types of absorbance detectors 12 have higher levels of robustness and measurement reproducibility than mass spectrometers. Therefore, it is preferable to use a liquid chromatograph 10 including an absorbance detector 12 as the main detector as in the previously described embodiment.

### Modes

It is evident to a person skilled in the art that the previously described illustrative embodiment is a specific example of the following modes of the present invention.

### Clause 1

One mode of the present invention is a device for processing data acquired by a liquid chromatograph including a column configured to separate compounds contained in a liquid sample as well as a main detector and a mass spectrometer both configured to detect compounds separated by the column, the main detector being a different type of detector from a mass spectrometer, the device including:
a storage section holding first chromatogram data acquired by the main detector and first mass spectrometry data acquired by the mass spectrometer by a measurement of a liquid sample containing a target compound under a first analysis condition, as well as second chromatogram data acquired by the main detector and second mass spectrometry data acquired by the mass spectrometer by a measurement of the liquid sample under a second analysis condition;
a chromatogram peak extractor configured to extract a first peak from the first chromatogram data and to extract a second peak from the second chromatogram data;
a mass-to-charge ratio acquirer configured to acquire, from the first mass spectrometry data, the mass-to-charge ratios of a plurality of ions detected at the position of the first peak and to acquire, from the second mass spectrometry data, the mass-to-charge ratios of a plurality of ions detected at the position of the second peak;
a molecular weight calculator configured to calculate, from the mass-to-charge ratios of the plurality of ions detected at the position of the first peak, the molecular weight of a compound corresponding to the plurality of ions, and to calculate, from the mass-to-charge ratios of the plurality of ions detected at the position of the second peak, the molecular weight of a compound corresponding to the plurality of ions; and
a peak correspondence determiner configured to determine the correspondence between the first peak and the second peak based on the molecular weight calculated for the first peak and the molecular weight calculated for the second peak.

In the data processing device for a liquid chromatograph according to Clause 1, the molecular weight of a compound corresponding to a plurality of ions detected by the mass spectrometer at the position of the first peak extracted from the first chromatogram data is calculated based on the mass-to-charge ratios of those ions. Furthermore, the molecular weight of a compound corresponding to a plurality of ions detected by the mass spectrometer at the position of the second peak extracted from the second chromatogram data is calculated based on the mass-to-charge ratios of those ions. The correspondence of the first peak and the second peak is subsequently determined based on the molecular weight calculated for the first peak and the molecular weight calculated for the second peak. According to the present invention, since peak tracking is performed based on the molecular weight rather than the spectral pattern of the mass spectrum, the peak tracking can be performed without being affected by an indefiniteness in the spectral pattern of the mass spectrum.

### Clause 2

In the data processing device for a liquid chromatograph according to Clause 2, which is a data processing device for a liquid chromatograph according to Clause 1, the target compound contains a substance selected from the group consisting of proteins, peptides and nucleic acids.

### Clause 3

In the data processing device for a liquid chromatograph according to Clause 3, which is a data processing device for a liquid chromatograph according to Clause 1 or 2, the molecular weight calculator is configured to calculate the molecular weight of the compound corresponding to the plurality of ions detected at the position of the first peak by a multiply charged ion analysis of the mass-to-charge ratios of the plurality of ions, and to calculate the molecular weight of the compound corresponding to the plurality of ions detected at the position of the second peak by a multiply charged ion analysis of the mass-to-charge ratios of the plurality of ions.

When a compound having a medium to high molecular weight such as a protein, peptide or nucleic acid is ionized, multiply charged ions are easily generated. Furthermore, the kinds and amounts of resultant multiply charged ions vary depending on the analysis condition. Therefore, the data processing device for a liquid chromatograph according to Clause 1 can be suitably used when the target compound contains a substance selected from the group consisting of proteins, peptides and nucleic acids as described in Clause 2. Furthermore, in such a case, a multiply charged ion analysis can be suitably used for calculating the molecular weight from the mass-to-charge ratios of ions as described in Clause 3.

### Clause 4

The data processing device for a liquid chromatograph according to Clause 4, which is a data processing device for a liquid chromatograph according to one of Clauses 1-3, further includes:
a compound information input receiver configured to receive an input of information including the molecular weight of the target compound; and
a compound identifier configured to compare the molecular weight calculated by the molecular weight calculator for the first peak and the second peak whose correspondence was determined by the peak correspondence determiner, with the inputted molecular weight to identify a combination of the first peak and the second peak corresponding to the target compound.

The data processing device for a liquid chromatograph according to Clause 4 can conveniently identify a peak set (a combination of the first peak and the second peak whose correspondence was determined by the peak correspondence determiner) corresponding to the target compound whose molecular weight has been entered by the user.

### Clause 5

In the data processing device for a liquid chromatograph according to Clause 5, which is a data processing device for a liquid chromatograph according to one of Clauses 1-4, the peak correspondence determiner is configured to determine the correspondence between the first peak and the second peak when the difference between the molecular weight calculated for the first peak and the molecular weight calculated for the second peak is smaller than a predetermined value.

The peak correspondence determiner in the data processing device for a liquid chromatograph according to Clause 1 may be configured, for example, to determine the correspondence between the first peak and the second peak when the difference between the molecular weight calculated for the first peak and the molecular weight calculated for the second peak is smaller than a predetermined value, as described in Clause 5. This allows for the correspondence between the first peak and the second peak to be determined even when there is a slight error due to the mass accuracy of the mass spectrometer or other factors. The predetermined value can be appropriately determined according to the mass accuracy of the used mass spectrometer (and other factors). The predetermined value does not always need to be an absolute value; for example, it may be a value determined by the ratio to the molecular weight of the target compound (when the molecular weight of the target compound is known).

### REFERENCE SIGNS LIST

1 . . . . Liquid Chromatograph System
10 . . . . Liquid Chromatograph
11 . . . . Component Separator
12 . . . . Absorbance Detector
13 . . . . Mass Spectrometer
20 . . . . Analyzing-and-Controlling Device
21 . . . . Storage Section
31 . . . . Compound Information Input Receiver
32 . . . . Analysis Condition Setter
33 . . . . Measurement Data Acquirer
34 . . . . Chromatogram Peak Extractor
35 . . . . Mass-to-Charge Ratio Acquirer
36 . . . . Molecular Weight Calculator
37 . . . . Peak Correspondence Determiner
38 . . . . Identifier
39 . . . . Analysis Result Display Processor
41 . . . . Input Unit
42 . . . . Display Unit
51 . . . . Scroll Bar

1. A data processing device for a liquid chromatograph which is a device for processing data acquired by a liquid chromatograph including a column configured to separate compounds contained in a liquid sample as well as a main detector and a mass spectrometer both configured to detect compounds separated by the column, the main detector being a different type of detector from a mass spectrometer, the device comprising:
a storage section holding first chromatogram data acquired by the main detector and first mass spectrometry data acquired by the mass spectrometer by a measurement of a liquid sample containing a target compound under a first analysis condition, as well as second chromatogram data acquired by the main detector and second mass spectrometry data acquired by the mass spectrometer by a measurement of the liquid sample under a second analysis condition;
a chromatogram peak extractor configured to extract a first peak from the first chromatogram data and to extract a second peak from the second chromatogram data;
a mass-to-charge ratio acquirer configured to acquire, from the first mass spectrometry data, mass-to-charge ratios of a plurality of ions detected at a position of the first peak and to acquire, from the second mass spectrometry data, mass-to-charge ratios of a plurality of ions detected at a position of the second peak;
a molecular weight calculator configured to calculate, from the mass-to-charge ratios of the plurality of ions detected at the position of the first peak, a molecular weight of a compound corresponding to the plurality of ions, and to calculate, from the mass-to-charge ratios of the plurality of ions detected at the position of the second peak, a molecular weight of a compound corresponding to the plurality of ions; and
a peak correspondence determiner configured to determine a correspondence between the first peak and the second peak based on the molecular weight calculated for the first peak and the molecular weight calculated for the second peak.

2. The data processing device for a liquid chromatograph according to claim 1, wherein the target compound contains a substance selected from a group consisting of proteins, peptides and nucleic acids.

3. The data processing device for a liquid chromatograph according to claim 1, wherein the molecular weight calculator is configured to calculate the molecular weight of the compound corresponding to the plurality of ions detected at the position of the first peak by a multiply charged ion analysis of the mass-to-charge ratios of the plurality of ions, and to calculate the molecular weight of the compound corresponding to the plurality of ions detected at the position of the second peak by a multiply charged ion analysis of the mass-to-charge ratios of the plurality of ions.

4. The data processing device for a liquid chromatograph according to claim 1, further comprising:
a compound information input receiver configured to receive an input of information including the molecular weight of the target compound; and
a compound identifier configured to compare the molecular weight calculated by the molecular weight calculator for the first peak and the second peak whose correspondence was determined by the peak correspondence determiner, with the inputted molecular weight to identify a combination of the first peak and the second peak corresponding to the target compound.

5. The data processing device for a liquid chromatograph according to claim 1, wherein the peak correspondence determiner is configured to determine the correspondence between the first peak and the second peak when a difference between the molecular weight calculated for the first peak and the molecular weight calculated for the second peak is smaller than a predetermined value.
